(19) United States
(12) Patent Application Publication
(10) Pub. No.: US 2004/0261076 A1
(43) Pub. Date: Dec. 23, 2004

(54) Program processing system, program processing method, and computer program

(75) Inventor: Hiroshi Kondo, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/817,792

(22) Filed: Apr. 6, 2004

(30) Foreign Application Priority Data
Apr. 9, 2003 (JP) 2003-105840

(51) Int. Cl. G06F 9/46

(52) U.S. Cl. 718/100

(57) ABSTRACT

An application program includes a plurality of tasks and is executed in a multitask environment to allow a plurality of functions to be provided. Tasks required for realizing each function to be provided and the execution order are defined as a session. A session manager formed as one of tasks manages resources for executing a called session and its execution state. The session operating side can realize a required function without being aware of the states of the individual tasks

### CROSS REFERENCE TO RELATED APPLICATION

This application claims priority from Japanese Priority Document No. 2003-015840, filed on Apr. 9, 2003 with the Japanese Patent Office, which document is hereby incorporated by reference.

### BACKGROUND OF THE INVENTION

1. Field of the Invention

The present invention relates to a program processing system, a program processing method, and a computer program for executing an application including a plurality of tasks, and more particularly, to a program processing system, a program processing method, and a computer program for executing an application in a multitask environment in which a plurality of tasks are artificially operated in parallel.

More specifically, the present invention relates to a program processing system, a program processing method, and a computer program for sharing the same task among a plurality of functions when an application operates the plurality of functions in parallel, and more particularly, to a program processing system, a program processing method, and a computer program for managing resources and the executing state of a task shared among a plurality of functions.

2. Description of Related Art

With innovative advances in LSI (Large Scale Integration) techniques in recent years, various types of information processing devices or information communication devices have been developed and introduced to the market, and penetrated in daily life. In the devices of such types, a CPU (Central Processing Unit) and other processors execute predetermined program codes to provide various processing services in an execution environment provided by an operating system.

Typically, the operating system has a multitask function in which a plurality of tasks are executed on a time division basis to make more tasks than processors look as if they are executed simultaneously. The use of a multitask operating system allows an application to be configured as sets of tasks for each function to artificially operate a plurality of tasks in parallel.

The operating system has a managing function for each task, but when a particular function is realized by a plurality of tasks, it does not provide a mechanism for collectively managing a series of tasks associated with the function. Specifically, it controls execution of each task in multitask processing but does not consider the relationship between tasks. Thus, each task must manage the relationship between tasks on its own to impair the ease of program writing and ease of maintainability.

In addition, a plurality of functions operating in parallel may wish to share the same task. However, the operating system does not provide a mechanism for managing the shared task.

### SUMMARY OF THE INVENTION

There is a need to provide a favorable program processing system, a program processing method, and a computer program which allow the same task to be shared among a plurality of functions when an application operates the plurality of functions in parallel.

There is another need to provide a favorable program processing system, a program processing method, and a computer program which allow preferable management of resources and the execution state of a task shared among a plurality of functions.

The present invention has been made in view of the aforementioned problem, and according to a first aspect thereof, the present invention provides a program processing system for executing a program including a plurality of tasks in a multitask environment provided by a multitask operating system capable of artificially executing a plurality of tasks in parallel, comprising session defining means for defining tasks required for realizing each function to be provided by the program and the execution order as a session, and session managing means for managing resources for executing a called session and its execution state.

The “system” herein refers to a logical collection of a plurality of devices (or a function module for realizing a particular function). It does not matter especially whether each device or the function module is present in a single housing or not.

The unit in which an operating system manages and controls program execution is typically referred to as “tasks.” The program processing system according to the embodiment allows a plurality of tasks to be present in a program and as a multitask function for executing the plurality of tasks on a time division basis and switching the tasks frequently to artificially execute the tasks in parallel. Thus, it looks as if more tasks exist than processors which are entities for performing actual calculations and those tasks are simultaneously executed.

The operating system, however, manages execution of the individual tasks but does not consider the relationship between the executed tasks.

Thus, in the present invention, tasks required for realizing a function and the execution order are defined as “a session” for each function service. The session managing means manages resources for executing a called session and the execution state. The resource management herein includes generation of instances of tasks included in a session, management of input/output performed by tasks, and the like. The session operating side can realize a required function without being aware of the state of individual tasks.

According to the present invention, the plurality of tasks can be collectively managed in the form of a session, and advantages can be provided in development in tasks such as execution efficiency, productivity, portability, and maintainability. In addition, since a task can be shared among sessions, development of applications can be performed more efficiently than conventional development for a single task.

The session managing means manages resources of a session by generating instances of tasks included in a session and managing input/output performed by tasks.

In addition, the session managing means operates and manages the execution state of a session in response to a request from outside of the program.

The session managing means has session registration means in which identification information of each session in the program and identification information of tasks constituting each session are previously defined statically. Thus, session start operation can be performed by simultaneously starting all tasks constituting a session.

The session managing means forms a session management table for recording identification numbers of a session and session constituent tasks and the operating states thereof upon start of the session and manages the session based thereon.

For example, the session managing means can interrupt or restart a session by simultaneously interrupting or restarting execution of session constituent tasks recorded in the session management table for the associated session having specified identification information.

The session managing means ends a session by forcefully ending simultaneously session constituent tasks recorded in the session management table, deleting the session management table, and releasing resources used by the tasks for the associated session having specified identification information.

The session managing means can control operation of tasks constituting a session in operation of the session by issuing a system call to the operating system.

According to a second aspect of the present invention, the present invention provides a computer program including a plurality of tasks and described in a computer readable form executed in a multitask environment provided by a multitask operating system capable of artificially executing a plurality of tasks in parallel to realize a plurality of functions, comprises session defining means for defining tasks required for realizing each function to be provided and the execution order as a session, and session managing means for managing resources for executing a called session and its execution state.

The computer program according to the second aspect of the present invention is a defined computer program described in a computer readable form to realize predetermined processing on a computer system. In other words, the computer program according to the second aspect of the present invention can be installed on a computer system to provide cooperative effects on the computer system to achieve the effects similar to those of the program processing system according to the first aspect of the present invention.

Other objects, characteristics, and advantages of the present invention will be apparent from more detailed description, later described, with reference to an embodiment of the present invention and the accompanying drawings.

### BRIEF DESCRIPTION OF THE DRAWINGS

FIG. 1 schematically shows the configuration of a program processing system used for realizing the present invention;

FIG. 2 schematically shows the configuration of an application program;

FIG. 3 schematically shows the configuration of an embedded application in a DVD record/playback device;

FIG. 4 shows an operation sequence when a playback session is started in the embedded application in the DVD record/playback device shown in FIG. 3; and

FIG. 5 shows an operation sequence when the playback session is ended in the embedded application in the DVD record/playback device shown in FIG. 3.

### DESCRIPTION OF THE PREFERRED EMBODIMENTS

An embodiment of the present invention is hereinafter described with reference to the drawings.

A. System Configuration

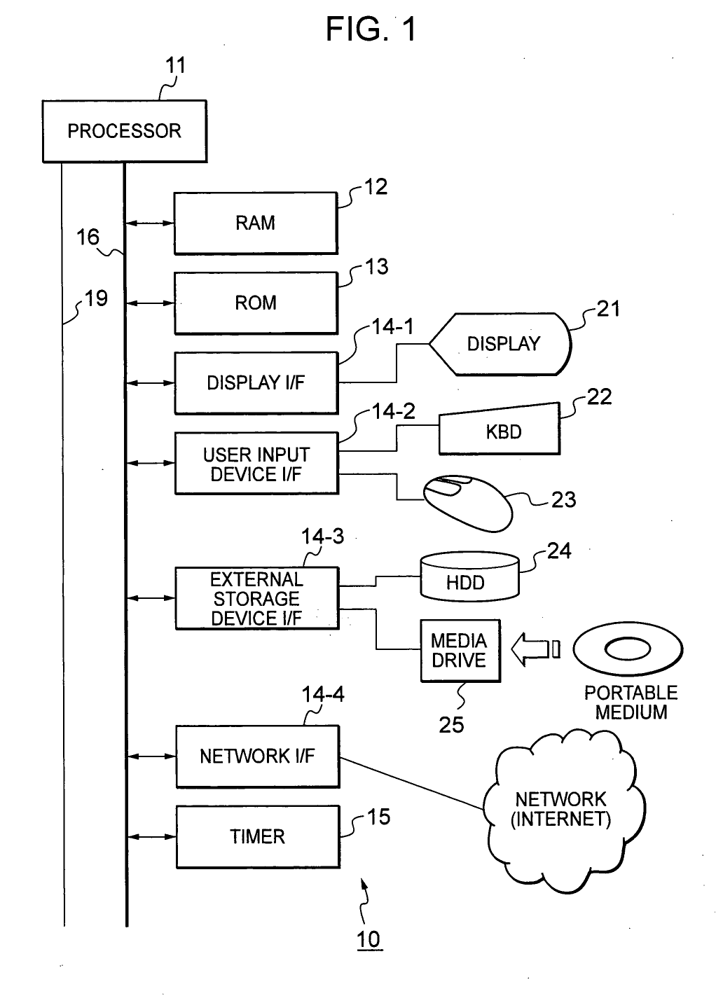

FIG. 1 schematically shows the configuration of a program processing system 10 used for realizing the present invention. As shown in FIG. 1, the program processing system 10 includes a processor 11, a RAM (Random Access Memory) 12, a ROM (Read Only Memory) 13, a plurality of input/output devices 14-1, 14-2, . . . , and a timer 15.

The processor 11 is a main controller for the operating processing system 10, and executes various types of program codes such as applications under control of an operating system (OS). The operating system is, for example, of an embedded type.

The unit in which the operating system manages and controls program execution is typically referred to as “tasks.” The program processing system 10 according to the embodiment allows a plurality of tasks to be present in a program and as a multitask function for executing the plurality of tasks on a time division basis and switching the tasks frequently to artificially execute the tasks in parallel. Thus, it looks as if more tasks exist than processors which are entities for performing actual calculations and those tasks are simultaneously executed.

The operating system assigns a task ID which allows the associated task to be distinguished from other tasks to each task processed by the processor 11 to mange execution of each task. However, the operating system does not consider the relationship between tasks executed.

On the other hand, an application program executed on the program processing system 10 includes a plurality of tasks executed in a multitask environment and can provide a plurality of functions. For example, an embedded application in a DVD record/playback apparatus provides a plurality of functions such as record to and playback from a record surface of a DVD. In this specification, tasks required for realizing a function and the execution order are defined as “a session” for each function service to be provided. In addition, a task called “a session manager” is provided to manage resources for executing a called session and the execution state. The resource management herein includes generation of instances of tasks included in a session, management of input/output performed by tasks, and the like. The session operating side can realize a required function without being aware of the state of individual tasks.

The processor 11 is connected with other devices (later described) through a bus 16. Each device on the system bus 16 is provided with a unique memory address or a unique I/O address which can be specified by the processor 11 to access a predetermined device. The system bus 16 is a common signal transmission path including an address bus, a data bus, and a control bus.

The RAM 12 is a writable memory and used for loading program codes to be executed by the processor 11 or temporarily storing work data of an execution program. The program codes include, for example, BIOS (Basic Input/Output System), device drivers for operating peripheral devices with hardware, an operating system, applications and the like.

The ROM 13 is a non-volatile memory for permanently storing predetermined codes or data, and for example, stores BIOS and POST (Power On Self Test).

The input/output devices 14 include a display interface 14-1 for connection to a display 21, a user input device interface 14-2 for connection to a user input device such as a keyboard 22 and a mouse 23, an external storage device interface 14-3 for connection to an external storage device such as a hard disk 24 and a media drive 25, a network interface card (NIC) 14-4 for connection to an external network, and the like. However, the types or configurations of the input/output devices 14 to be provided depend on the entity of the program processing system 10. For example, when the system is a DVD record/playback apparatus, the input/output devices include a multiplexing device, a demultiplexing device, a video signal control device, an audio signal control device, and the like.

The display interface 14-1 is a dedicated interface controller for actually processing an imaging instruction provided by the processor 1. The imaging data processed by the display interface 14-1 is once written, for example, to a frame buffer (not shown), and then output on a screen by the display 21.

The HDD 24 is an external storage device (known) having a magnetic disc mounted fixedly as a storage carrier, and is more favorable than other external storage devices in its storage capacity and data transfer speed. Typically, the HDD 24 has program codes of the operating system to be executed by the processor 11, application programs, device drivers and the like stored therein in a non-volatile manner. Placing a software program in an executable state on the HDD 24 is referred to as “installation” of the program on the system. For example, it is possible to install on the HDD 24 an operating system or an application program which includes a plurality of tasks and has a session formed of a set of tasks for each function defined therein.

The media drive 25 is a device for loading a portable medium such as a CD (Compact Disc), an MO (Magneto-Optical disc), and a DVD (Digital Versatile Disc) to access a data record surface thereof.

The portable medium is used mainly for the purpose of backing up software programs or data files as computer readable data or transporting them between systems (including sale, circulation, and distribution). For example, it is possible to physically circulate and distribute an operating system or an application program which includes a plurality of tasks and has a session formed of a set of tasks for each function defined therein among a plurality of devices by using such portable media.

The network interface 14-4 can connect the system 10 to a local network such as a LAN (Local Area Network) or to a wide area network such as the Internet in accordance with a predetermined communication protocol such as Ethernet®.

On a network, a plurality of host terminals (not shown) are connected transparently to constitute a distributed computing environment. Software programs or data contents can be delivered over the network. For example, it is possible to download through the network an operating system and an application program which includes a plurality of tasks and has a session formed of a set of tasks for each function defined therein.

Each of the input/output devices 14-1, 14-2, . . . is assigned an interrupt level and can make a notification to the processor 11 through an interrupt request signal line 19 in response to occurrence of a predetermined event (for example, GUI processing such as keyboard input and mouse click, or completion of data transfer in the hard disk). In response to such an interrupt request, the processor 11 executes an interrupt handler associated therewith.

The timer 15 is a device for generating a timer signal at predetermined intervals. The timer 15 is also assigned an interrupt level to generate a periodical interrupt to the processor 11 through the interrupt request signal line 19.

B. Configuration of Application Program

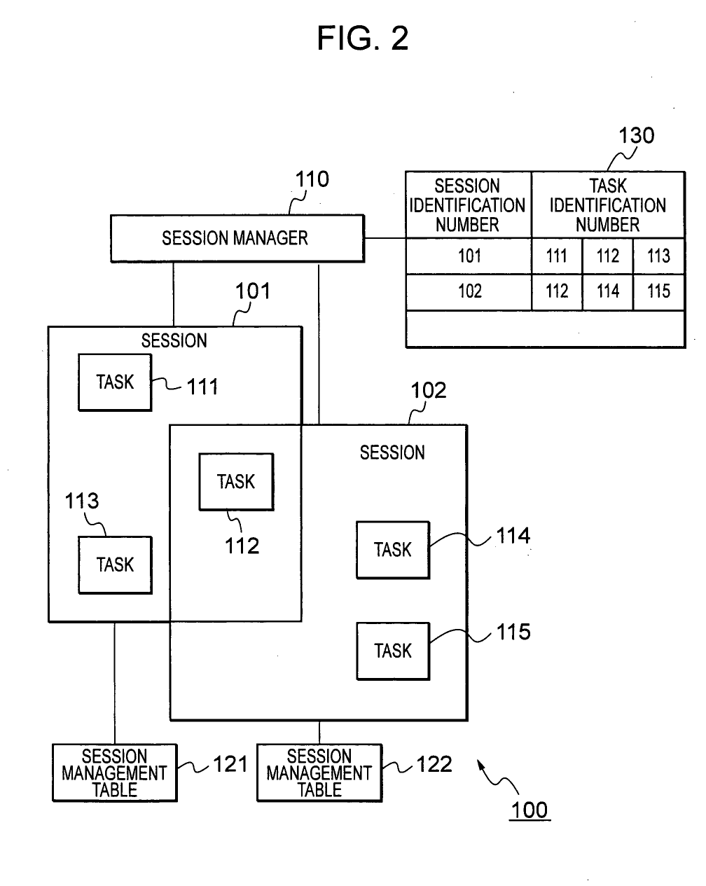

In the embodiment, an application program consists a plurality of tasks executed in a multitask environment and can provide a plurality of functions. FIG. 2 schematically shows the configuration of an application program 100.

With the application program 100 shown, a plurality of tasks operating in parallel cooperate to realize a particular function. The series of operations is referred to as a session. Tasks associated with the operation of the session are referred to as session constituent tasks. In the example shown, a session 101 formed of a task 111, a task 112, and a task 113 executed in this order, and a session 102 formed of the task 112, a task 114, and a task 115 executed in this order are defined.

One of the tasks constituting the application program 100 is a session manager 110 which manages execution of operation for each session. The session manager 110 has a session registration table 130 previously defined statically for collectively managing all sessions in the application program 100. The session registration table 130 has stored therein an identification number of each session, identification numbers and the execution order of tasks constituting each session, and hardware resources used in each session.

The session registration table 130 has task identification numbers registered therein, the number of which is equal to the number of tasks constituting sessions. In this event, it is possible that different sessions have the same task registered therefor. In the example shown in FIG. 2, the task 112 is registered in both of the session 101 and the session 102.

The session manager 110 uses the session registration table 130 to manage resources for executing a session and the execution state. The resource management herein includes generation of instances of tasks included in a session, management of input/output performed by tasks, and the like.

In a session, similarly to tasks, the execution state of operation such as start, interruption, restart, and end can be changed. The operation and management of the execution state in sessions are performed by the session manager 110 in response to a request from outside of the program.

For operating a session, the session manager 110 collectively operates all the tasks constituting the session, so that the session operation requesting side does not need to be aware of the individual session constituent tasks.

A session is started by the session manager 110 reading identification numbers of tasks constituting the session from the session registration table 130 to start the associated tasks simultaneously. In this event, the session manager 110 forms a session management table for the associated session and records the identification numbers of the session and the respective session constituent tasks and the operating states for monitoring.

A session is interrupted and restarted by the session manager 110 simultaneously interrupting and restarting execution of session constituent tasks recorded in a session management table for the associated session having a specified identification number.

A session is ended by the session manager 110 forcefully ending session constituent tasks simultaneously and deleting a session management table of the associated session.

The operation of each of tasks constituting a session in the aforementioned session operation is controlled by the session manager 110 issuing a system call to the operating system. A plurality of sessions can be registered in a single application program and a plurality of sessions can be simultaneously operated in parallel. It is also possible that a plurality of sessions of the same type can be operated simultaneously. In addition, the same task can be shared among different types of sessions.

C. SPECIFIC EXAMPLE

In the previous section B, description are made in which the application program including a plurality of tasks and executed in a multitask environment defines tasks required for realizing each function to be provided thereby and the execution order of the tasks as a session, and the session manager formed as one of the tasks manages resources for executing a called session and the execution state. Thus, the plurality of tasks can be collectively managed in the form of a session, and advantages can be provided in development in tasks such as execution efficiency, productivity, portability, and maintainability. In addition, the session operating side can realize a required function without being aware of the states of individual tasks. Furthermore, since a task can be shared among sessions, application development can be performed more efficiently than conventional development for a single task.

In the section C, the function, the configuration, and the effects of the application program according to the present invention are described with an embedded application in a DVD record/playback device as an example.

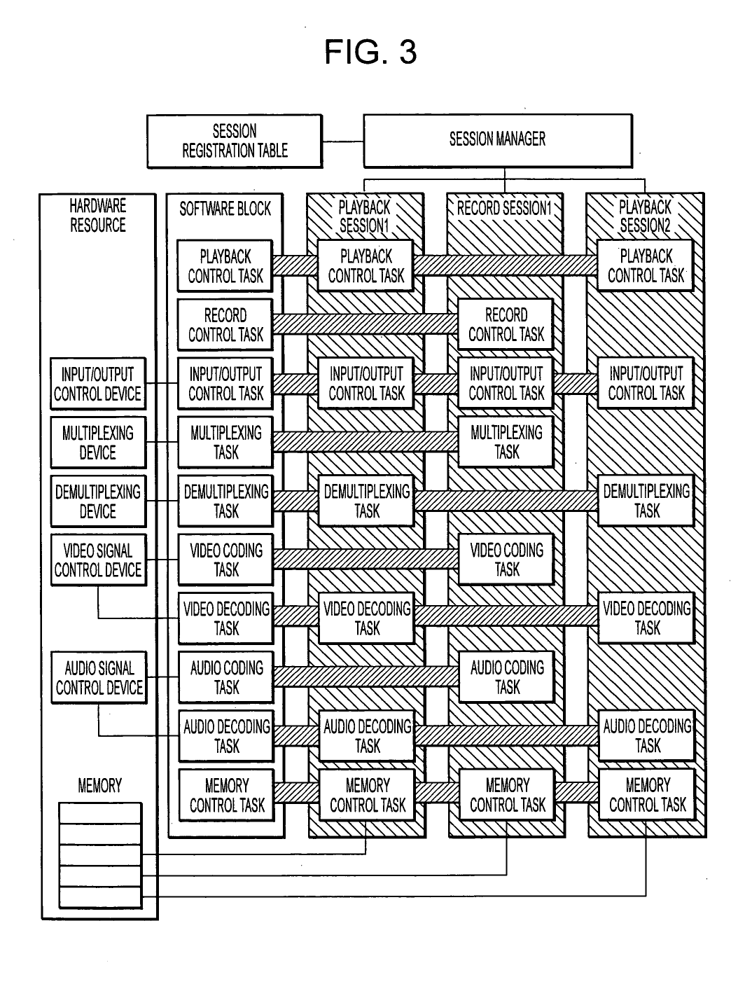

FIG. 3 schematically shows the configuration of an embedded application in a DVD record/playback device.

The application program includes a plurality of tasks. In the example shown, the tasks constituting the application program are stored in a software block (except for a session manager), and include a playback control task, a record control task, an input/output control task, a multiplexing task, a demultiplexing task, a video coding task, a video decoding task, an audio coding task, an audio decoding task, a memory control task, and the like. Each task in the application program uses hardware resources possessed by the system 10. For example, the input/output control task uses an input/output control device, the multiplexing task uses a multiplexing device, the demultiplexing task uses a demultiplexing device, the video coding task and the video decoding task use a video signal control device, the audio coding task and the audio decoding task use an audio signal control device, and the memory control task uses a memory.

In the application, a plurality of tasks operating in parallel cooperate to realize a particular function such as playback from or record to a record surface of a DVD disc. A series of operations associated with the playback or record is referred to as “a playback session” or “a record session.”

In the example shown, the playback session is defined by session constituent tasks including the playback control task, the input/output control task, the demultiplexing task, the video decoding task, audio decoding task, and the memory control task. The record session is defined by session constituent tasks including the record control task, the input/output control task, the multiplexing task, the video coding task, the audio coding task, and the memory control task.

One of the tasks constituting the application program is the session manager which manages execution of operation for each session. The session manager has a session registration table previously defined statically for collectively managing all sessions in the application program. The session registration table has stored therein an identification number of each session such as the playback session and the record session, identification numbers and the execution order of tasks constituting each session, and hardware resources used in each session.

The session registration table has task identification numbers registered therein, the number of which is equal to the number of tasks constituting sessions. In this event, it is possible that different sessions have the same task registered. In the example shown in FIG. 3, the input/output control task and the memory control task are registered in both of the playback session and the record session.

When open of a session is directed from the outside, the session manager refers to the session registration table to acquire task constituting the session and hardware resources used by the respective tasks. The session manager generates instances of session constituent tasks and manages input to an output from the hardware resources by the instances.

In the session, similarly to tasks, the execution state of operation such as start, interruption, restart, and end can be changed. The operation and management of the execution state in sessions are performed by the session manager in response to a request from the outside. When the session is operated, the session manager collectively operates all the tasks constituting the session, so that the session operation requesting side does not need to be aware of the individual session constituent tasks.

In the example shown in FIG. 3, a plurality of sessions are registered including the playback session and the record session. In the example shown, the plurality of sessions such as the playback session and the record session are simultaneously operated in parallel. In addition, two playback sessions are simultaneously operated. Furthermore, the input/output control task and the memory control task are shared between the different types of sessions, that is, the playback session and the record session. A playback session 1, a record session 2, and a playback session 2 show conceptual drawings of generated instances of the session constituent tasks in the software block.

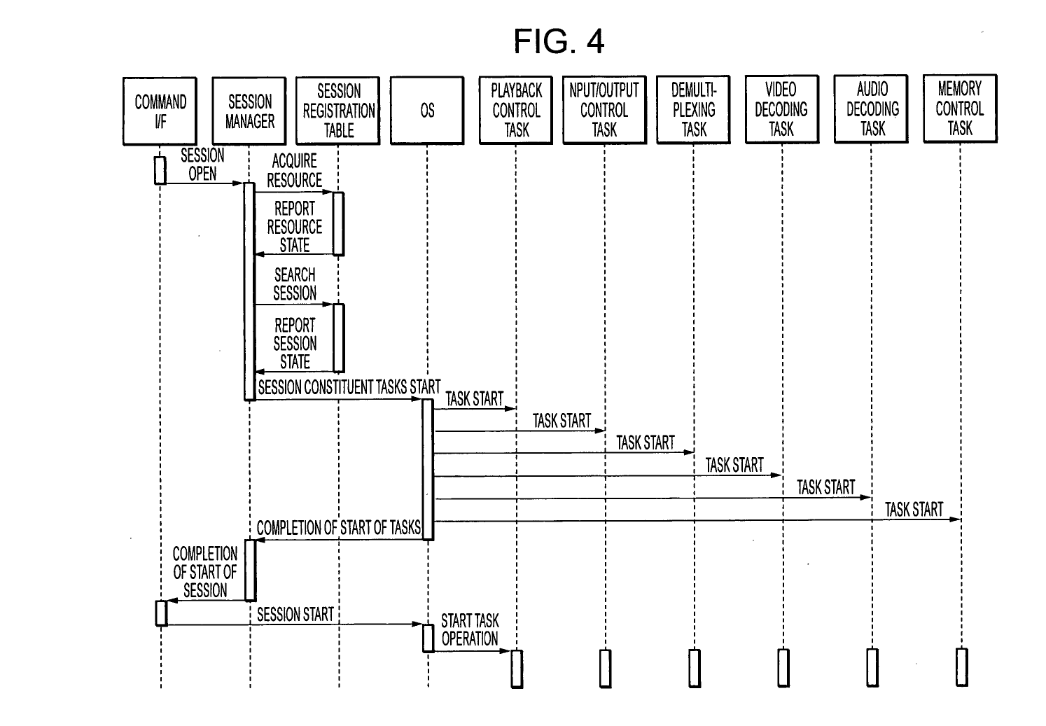

FIG. 4 shows an operation sequence performed when the playback session is started in the embedded application in the DVD record/playback device shown in FIG. 3.

The session is started by the session manager reading identification numbers of tasks constituting the session from the session registration table to start the associated tasks simultaneously.

Specifically, when a command interface directs open of a session, the session manager forms a session management table (not shown) for the associated session. Specifically, the session manager makes an inquiry to the session registration table to acquire hardware resources and write the state of each hardware resource to the session management table. In addition, the session manager searches for tasks constituting the playback session and writes the state of the session to the session management table.

Next, the session manager simultaneously starts all the tasks constituting the playback session. The task start operation is controlled by the session manager issuing a system call to the operating system. Specifically, in response to the system call from the session manager, the operating system simultaneously starts all the tasks constituting the playback session including the playback control task, the input/output control task, the demultiplexing task, the video decoding task, the audio decoding task, and the memory control task.

Upon completion of the start of all the tasks constituting the playback session, the operating system notifies the session manager of the completion of the start of the task. Then, the session manager notifies the command interface of the completion of the start of the playback session.

Thereafter, the session is started, and the operating system starts operation of each task in accordance with an instruction of the command interface.

When the session is started, the session manager forms a session management table (not shown) for the associated session and records the identification numbers of the session and each session constituent task and the operating state for monitoring.

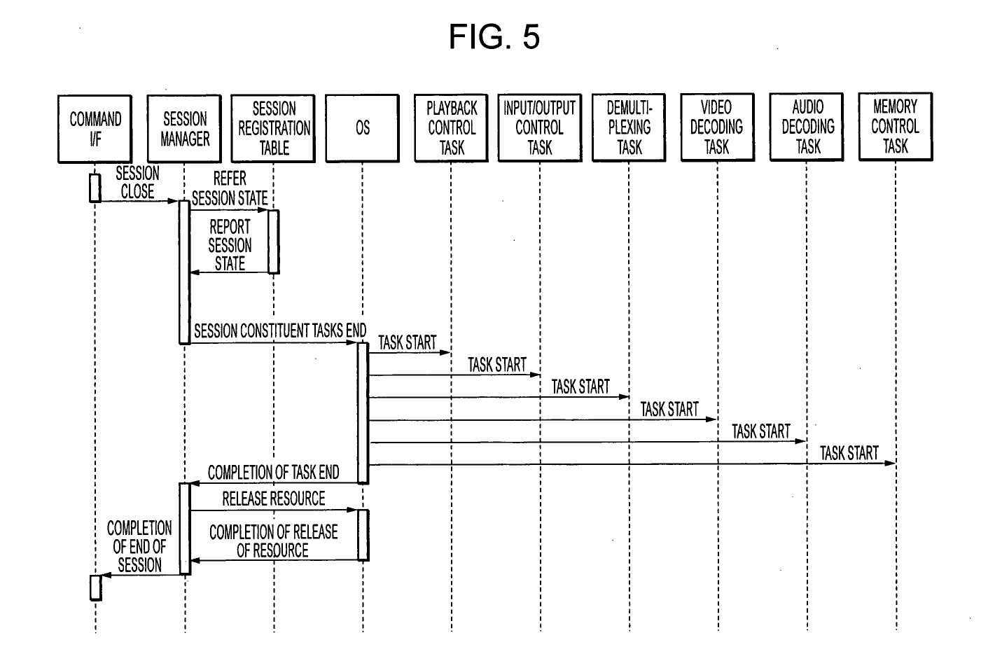

FIG. 5 shows an operation sequence performed when the playback session is ended in the embedded application in the DVD record/playback device shown in FIG. 3.

For ending the session, the session manager forcefully ends all the tasks constituting the playback session simultaneously and deletes the session management table of the associated session.

Specifically, when the command interface directs close of the session, the session manager refers to the state of the session in the session management table to acquire the state of the playback session, and then issues a system call to the operating system for ending all the tasks constituting the session.

In response to the system call, the operating system simultaneously ends all the tasks constituting the playback session including the playback control task, the input/output control task, the demultiplexing task, the video decoding task, the audio decoding task, and the memory control task.

Upon completion of the end of all the tasks constituting the playback session, the operating system notifies the session manager of the completion of the task end. Then, the session manager refers to the session management table to release the hardware resources used by the session constituent tasks and deletes the session management table. The session manager notifies the command interface of the completion of the end of the session.

As apparent from the description of FIG. 4 to FIG. 5, the session operating side, that is, the command interface can realize a required function without being aware of the states of the individual tasks.

The present invention has been described with reference to the specific embodiment. However, it is apparent that those skilled in the art can made modifications and substitutions of the embodiment without departing from the scope of the present invention. In other words, the present invention has been disclosed in the form of illustration, and the described contents of the specification should not be interpreted as limiting. Reference should be made to the claims to determine the scope of the present invention.

What is claimed is:

1. A program processing system for executing a program including a plurality of tasks in a multitask environment provided by a multitask operating system capable of artificially executing a plurality of tasks in parallel, comprising:
session defining means for defining tasks required for realizing each function to be provided by the program and the execution order as a session; and
session managing means for managing resources for executing a called session and its execution state.

2. The program processing system as cited in claim 1, wherein:
the session managing means manages resources of a session by generating instances of tasks included in a session and managing input/output performed by tasks.

3. The program processing system as cited in claim 1, wherein:
the session managing means operates and manages the execution state of a session in response to a request from outside of the program.

4. The program processing system as cited in claim 1, wherein:
the session managing means has session registration means in which identification information of each session in the program and identification information of tasks constituting each session are previously defined statically, and performs a session start operation by simultaneously starting all tasks constituting a session.

5. The program processing system as cited in claim 4, wherein:
the session managing means forms a session management table for recording identification numbers of a session and session constituent tasks and the operating states thereof upon start of the session, and manages the session based thereon.

6. The program processing system as cited in claim 5, wherein:
the session managing means interrupts or restarts a session by simultaneously interrupting or restarting execution of all session constituent tasks recorded in the session management table for the associated session having specified identification information.

7. The program processing system as cited in claim 5, wherein:
the session managing means ends a session by ending simultaneously all session constituent tasks recorded in the session management table, and deletes the session management table for the associated session having specified identification information.

8. The program processing system as cited in claim 1, wherein:
session managing means controls operation of tasks constituting a session in operation of the session by issuing a system call to the operating system.

9. A program processing method for executing a program including a plurality of tasks in a multitask environment provided by a multitask operating system capable of artificially executing a plurality of tasks in parallel, comprising the steps of:
session defining step for defining tasks required for realizing each function to be provided by the program and the execution order as a session; and
session managing step for managing resources for executing a called session and its execution state.

10. The program processing method as cited in claim 9, wherein:
the session managing step manages resources of a session by generating instances of tasks included in a session and managing input/output performed by tasks.

11. The program processing method as cited in claim 9, wherein:
the session managing step operates and manages the execution state of a session in response to a request from outside of the program.

12. The program processing system as cited in claim 9, wherein:
the session managing step previously and statically registers identification information of each session in the program and identification information of tasks constituting each session, and performs a session start operation by simultaneously starting all tasks constituting a session.

13. The program processing method as cited in claim 12, wherein:
the session managing step forms a session management table for recording identification numbers of a session and session constituent tasks and the operating states thereof upon start of the session, and manages the session based thereon.

14. The program processing method as cited in claim 13, wherein:
the session managing step interrupts or restarts a session by simultaneously interrupting or restarting execution of all session constituent tasks recorded in the session management table for the associated session having specified identification information.

15. The program processing method as cited in claim 13, wherein:
the session managing step ends a session by ending simultaneously all session constituent tasks recorded in the session management table, and deletes the session management table for the associated session having specified identification information.

16. The program processing method as cited in claim 1, wherein:
session managing step controls operation of tasks constituting a session in operation of the session by issuing a system call to the operating system.

17. A computer program described in a computer readable form so as to perform a plurality of functions executed under multitask environment provided by a multitask operating system capable of artificially executing a plurality of tasks in parallel, comprising:
session defining means for defining tasks required for realizing each function to be provided by the program and the execution order as a session; and
session managing means for managing resources for executing a called session and its execution state.

18. The computer program as cited in claim 17, wherein:
the session managing means includes tasks constituting the computer program.

19. The computer program as cited in claim 17, wherein:
the session managing means manages resources of a session by generating instances of tasks included in a session and managing input/output performed by tasks.

20. The computer program as cited in claim 17, wherein:
the session managing means operates and manages the execution state of a session in response to a request from outside of the computer program.

21. The computer program as cited in claim 17, wherein:
the session managing means has session registration means in which identification information of each session in the computer program and identification information of tasks constituting each session are previously defined statically, and performs a session start operation by simultaneously starting all tasks constituting a session.

22. The computer program as cited in claim 21, wherein:
the session managing means forms a session management table for recording identification numbers of a session and session constituent tasks and the operating states thereof upon start of the session, and manages the session based thereon.

23. The computer program as cited in claim 22, wherein:
the session managing means interrupts or restarts a session by simultaneously interrupting or restarting execution of all session constituent tasks recorded in the session management table for the associated session having specified identification information.

24. The computer program as cited in claim 22, wherein:
the session managing means ends a session by ending simultaneously all session constituent tasks recorded in the session management table, and deletes the session management table for the associated session having specified identification information.

25. The computer program as cited in claim 17, wherein:
session managing means controls operation of tasks constituting a session in operation of the session by issuing a system call to the operating system.

26. A computer program described in a computer readable form so as to perform process of program constituting a plurality of tasks under multitask environment provided by a multitask operating system capable of artificially executing a plurality of tasks in parallel, comprising:
session defining step for defining tasks required for realizing each function to be provided by the program and the execution order as a session; and
session managing step for managing resources for executing a called session and its execution state.
